(19) United States
(12) Patent Application Publication
(10) Pub. No.: US 2013/0318324 A1
(43) Pub. Date: Nov. 28, 2013

(54) MINICORE-BASED RECONFIGURABLE PROCESSOR AND METHOD OF FLEXIBLY PROCESSING MULTIPLE DATA USING THE SAME

(71) Applicant: Dong-Kwan SUH, Hwaseong-si (KR)

(72) Inventor: Dong-Kwan SUH, Hwaseong-si (KR)

(73) Assignee: Samsung Electronics Co., Ltd., Suwon-si (KR)

(21) Appl. No.: 13/766,173

(22) Filed: Feb. 13, 2013

(30) Foreign Application Priority Data
May 24, 2012 (KR) 10-2012-0055621

(51) Int. Cl. G06F 15/80

(52) U.S. Cl. CPC G06F 15/8023
USPC 712/22

(57) ABSTRACT

A minicore-based reconfigurable processor and a method of flexibly processing multiple data using the same are provided. The reconfigurable processor includes minicores, each of the minicores including function units configured to perform different operations, respectively. The reconfigurable processor further includes a processing unit configured to activate two or more function units of two or more respective minicores, among the minicores, that are configured to perform an operation of a single instruction multiple data (SIMD) instruction, the processing unit further configured to execute the SIMD instruction using the activated two or more function units.

### CROSS-REFERENCE TO RELATED APPLICATION

This application claims the benefit under 35 U.S.C. §119(a) of a Korean Patent Application No. 10-2012-0055621, filed on May 24, 2012, in the Korean Intellectual Property Office, the entire disclosure of which is incorporated herein by reference for all purposes.

### BACKGROUND

1. Field

The following description relates to a minicore-based reconfigurable processor and a method of flexibly processing multiple data using the same.

2. Description of the Related Art

A reconfigurable architecture is an architecture that can alter a hardware configuration of a computing device based on tasks to be performed by the computing device. There are a number of types of reconfigurable architecture, for example, a coarse-grained array (CGA). A CGA includes function units of the same computing power, and a connection state between the function units may be changed according to each task to be performed.

A reconfigurable processor may include a CGA mode. In the CGA mode, the reconfigurable processor includes an array structure that simultaneously performs multiple operations (e.g., processes application domains) in order to accelerate a loop or data. To support various application domains, intrinsics are added to the reconfigurable processor, and a total number of operations is increased. Therefore, designing the reconfigurable processor such that one function unit processes all of the operations requires an additional pipeline, and adversely affects performance.

### SUMMARY

In one general aspect, there is provided a reconfigurable processor including minicores, each of the minicores including function units configured to perform different operations, respectively. The reconfigurable processor further includes a processing unit configured to activate two or more function units of two or more respective minicores, among the minicores, that are configured to perform an operation of a single instruction multiple data (SIMD) instruction, the processing unit further configured to execute the SIMD instruction using the activated two or more function units.

One of the function units included in one of the minicores may perform a same operation as one of the function units included in another one of the minicores or in each other one of the minicores.

The processing unit may be further configured to determine the two or more minicores, which are to execute the SIMD instruction, based on a data type of the SIMD instruction.

Each of the minicores may be configured to temporarily store a result of the execution of the SIMD instruction.

The reconfigurable processor may further include an external network configured to connect the minicores to each other.

Each of the minicores may further include an internal network configured to connect the function units to each other.

The processing unit may be further configured to operate as a minicore-based coarse-grained array (CGA) processor, or as a minicore-based very long instruction word (VLIW) processor.

Each of the minicores may include a basic design unit or a basic extension unit in the CGA processor or the VLIW processor.

The CGA processor may be configured to perform a loop operation. The VLIW processor may be configured to perform an operation other than the loop operation.

The processing unit may be further configured to identify a data type of the SIMD instruction, the data type including an amount of bits of data.

In another general aspect, there is provided a method of processing multiple data using a reconfigurable processor, the method including determining two or more minicores, among minicores of the reconfigurable processor, that are to execute a SIMD instruction. The method further includes activating two or more function units of the determined two or more minicores, respectively, that perform an operation of the SIMD instruction.

The determining of the two or more minicores may include determining the two or more minicores, which are to execute the SIMD instruction, based on a data type of the SIMD instruction.

The method may further include executing the SIMD instruction using the activated two or more function units.

The method may further include storing a result of the execution of the SIMD instruction.

The method may further include operating as a minicore-based CGA processor, or as a minicore-based VLIW processor.

The method may further include identifying a data type of the SIMD instruction, the data type including an amount of bits of data.

A computer-readable storage medium may store a program to process the multiple data, including instructions to cause a computer to implement the method.

Other features and aspects will be apparent from the following detailed description, the drawings, and the claims.

### BRIEF DESCRIPTION OF THE DRAWINGS

FIG. 1 is a diagram illustrating an example of a reconfigurable processor.

FIG. 2 is a diagram illustrating another example of a reconfigurable processor.

FIG. 3 is a diagram illustrating an example of a minicore of a reconfigurable processor.

FIG. 4 is a diagram illustrating an example of single instruction multiple data (SIMD) resources formed flexibly in a coarse-grained array (CGA) mode.

FIG. 5 is a flowchart illustrating an example of a method of flexibly processing multiple data using a reconfigurable processor.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein.

Accordingly, various changes, modifications, and equivalents of the systems, apparatuses and/or methods described herein will be suggested to those of ordinary skill in the art. Also, descriptions of well-known functions and constructions may be omitted for increased clarity and conciseness

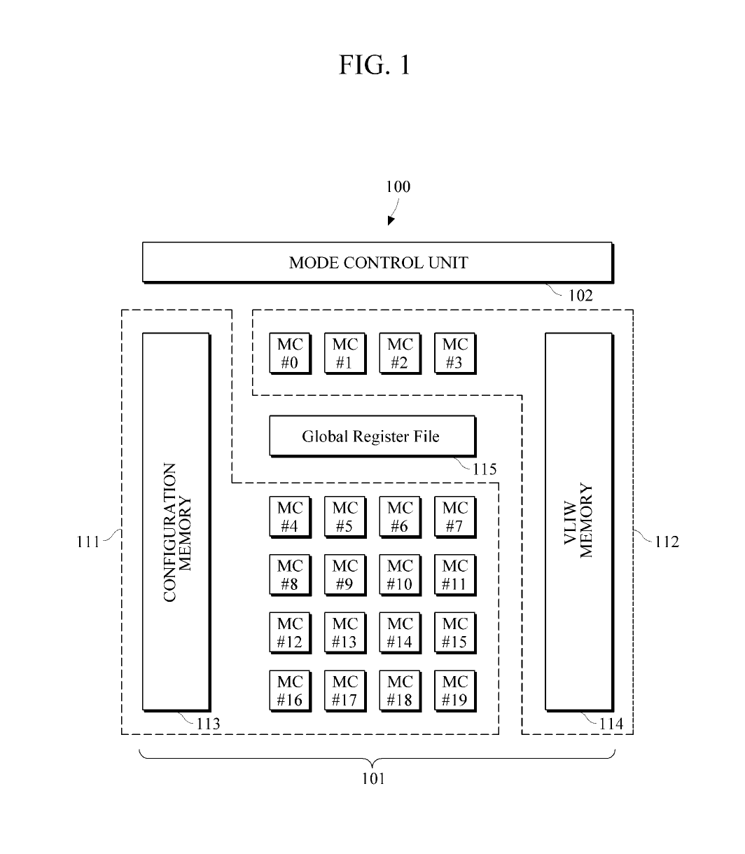

FIG. 1 is a diagram illustrating an example of a reconfigurable processor 100. Referring to FIG. 1, the reconfigurable processor 100 includes a processing unit 101 and two or more minicores MC#0 through MC#19.

The reconfigurable processor 100 supports single instruction multiple data (SIMD) processing, which processes multiple data using the same instruction. The processing unit 101 and the minicores MC#0 through MC#19 may be flexibly configured to support the SIMD processing.

In more detail, each of the minicores MC#0 through MC#19 may be a basic design unit or a basic extension unit of the reconfigurable processor 100. Each of the minicores MC#0 through MC#19 may include full computing power. The computing power refers to an operation processing capability, that is, how many types of operations a system can process. Therefore, the computing power of the system is defined based on the types of operations the system can process.

For example, a system that can process operations A and B includes different computing power than a system that can process operations C and D. In another example, a system that can process operations A, B and C includes different computing power than a system that can process operations A, B, C and D. In this example, the latter system includes higher or greater computing power than the former system. The operations A, B, C and D may be, for example, ‘addition’, ‘multiplication’, ‘OR’, and ‘AND’, respectively. However, these are merely examples, and the scope of the example of FIG. 1 is not limited to the example operations. That is, the example of FIG. 1 can also be applied to various other operations including, for example, an arithmetic operation, a logic operation, a scalar operation, a vector operation, and/or other operations known to one of ordinary skill in the art.

Each of the minicores MC#0 through MC#19 may include two or more function units. The function units included in each of the minicores MC#0 through MC#19 may be configured to perform different operations, respectively. That is, the reconfigurable processor 100 distributes all of the operations to the respective function units, so that almost all or all of the operations can be performed by a set of the function units, that is, a minicore. Thus, each minicore can include full computing power.

If one function unit is to process all of the operations in SIMD processing, a data processing time may be increased, and an additional pipeline may be needed to solve this problem. In the example of FIG. 1, however, since the minicore-based reconfigurable processor 100 distributes all of the operations to the respective function units, the reconfigurable processor 100 can flexibly support the SIMD processing without additional bandwidth or resources.

The processing unit 101 supports any SIMD instruction, including an operation, by combining minicores MC#0 through MC#19 in various ways. That is, the processing unit 101 determines minicores that are to process a SIMD instruction based on a data type (e.g., an amount of bits of data) of the SIMD instruction, and activates function units included in the determined minicores that perform the same operation, so that the activated function units execute the SIMD instruction. A function unit of each minicore is a function unit that performs a respective operation corresponding to the SIMD instruction. The determined minicores that are to process the SIMD instruction are determined further based on a data size that each function unit of each minicore can process.

For example, if each function unit of a minicore can process 32 bits of data, and if a data type of a decoded SIMD instruction is 64 bits for an ADD operation, function units of two minicores that perform the ADD operation are combined to execute the SIMD instruction. In addition, if each function unit of a minicore can process 32 bits of data, and if a data type of a decoded SIMD instruction is 128 bits, four minicores are combined to execute the SIMD instruction. Accordingly, the reconfigurable processor 100 flexibly supports a SIMD instruction based on a data type of the SIMD instruction.

The processing unit 101 includes two operation modes. For example, the processing unit 101 includes a coarse-grained array (CGA) mode of processing a loop operation, and includes a very long instruction word (VLIW) mode of processing operations other than the loop operation.

In the CGA mode, the processing unit 101 operates as a CGA module 111. The CGA module 111 includes 16 minicores MC#4 through MC#19 and a configuration memory 113. Each of the minicores MC#4 through MC#19 can process a loop operation in parallel. A connection or a network structure of the minicores MC#4 through MC#19 is optimized for a type of the loop operation that the CGA module 111 intends to process. Configuration information indicating the connection or the network structure of the minicores MC#4 through MC#19 is stored in the configuration memory 113. In other words, in the CGA mode, the processing unit 101 operating as the CGA module 111 processes the loop operation based on the configuration information stored in the configuration memory 113.

In the VLIW mode, the processing unit 101 operates as a VLIW module 112. The VLIW module 112 includes four minicores MC#0 through MC#3 and a VLIW memory 114. Each of the minicores MC#0 through MC#3 processes a very long instruction stored in the VLIW memory 114 based on a VLIW architecture. In other words, in the VLIW mode, the processing unit 101 operating as the VLIW module 112 processes an operation based on a very long instruction stored in the VLIW memory 114.

In another example, some minicores may be shared by the VLIW mode and the CGA mode. For example, in FIG. 1, the minicores MC#5 through MC#8, which are used in the CGA mode, may operate as VLIW machines in the VLIW mode.

The reconfigurable processor 100 further includes a mode control unit 102 and a global register file (GRF) 115. The mode control unit 102 controls a switch of an operation mode of the processing unit 101 from the CGA mode to the VLIW mode, or from the VLIW mode to the CGA mode. The mode control unit 102 may generate a mode switch signal or a mode switch command, and transmit the mode switch signal or the mode switch command to the processing unit 101, to control the switch of the operation mode of the processing unit 101.

For example, while processing a loop operation in the CGA mode, the processing unit 101 may switch to the VLIW mode in response to a mode switch signal received from the mode control unit 102, and then process an operation other than the loop operation. A result of processing the loop operation is temporarily stored in the GRF 115. Also, while operating in the VLIW mode, the processing unit 101 may switch to the CGA mode in response to a mode switch signal received from the mode control unit 102. Then, the processing unit 101 may retrieve context information, e.g., the result of processing the previous loop operation, from the GRF 115, and continue to process the previous loop operation. For a mode switch, the global register file 115 may temporarily store live-in/live-out data during the mode switch.

As described above, in the example of FIG. 1, full computing power, that is, a capability of performing all operations, is divided and distributed to respective function units, and the function units are combined into a minicore, which is a basic processing unit. This minimizes unnecessary consumption of resources in a high frequency environment, while improving performance. In addition, minicores are flexibly combined to execute various SIMD instructions. Therefore, SIMD processing is supported without additional resources or bandwidth.

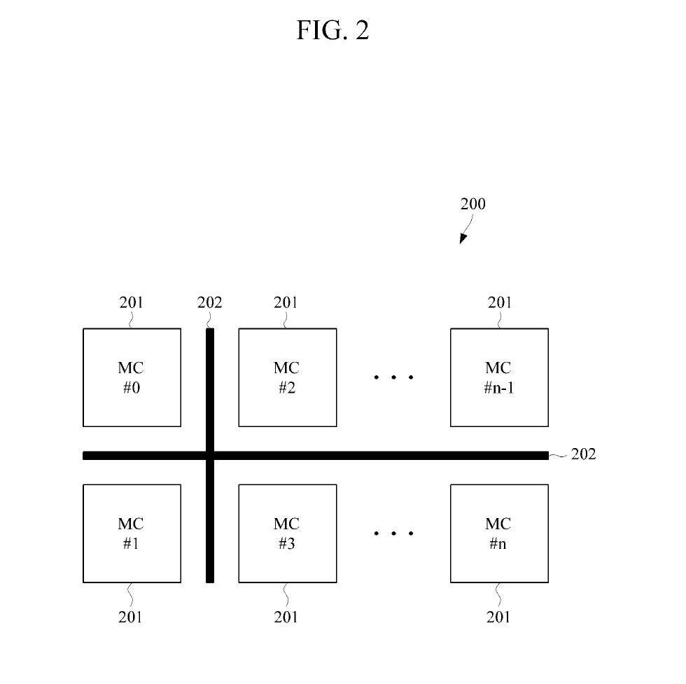

FIG. 2 is a diagram illustrating another example of a reconfigurable processor 200. Referring to FIG. 2, the reconfigurable processor 200 includes two or more minicores 201 and an external network 202 that connects the minicores 201 to each other.

The minicores 201 may process instructions, jobs, tasks, and/or other items known to one of ordinary skill in the art, independently of each other. For example, the minicores 201 (e.g., MC#0 and MC#1) may simultaneously process two independent instructions, respectively. In another example, two or more different minicores may process the same instruction. In this example, the minicores may process multiple data for the same instruction, e.g., perform SIMD processing.

Each of the minicores 201 may be a basic design unit or a basic extension unit of the reconfigurable processor 200. As shown in FIG. 2, a number n of the minicores 201 can be increased or decreased as desired.

The external network 202 enables the minicores 201 to communicate with each other. For example, data generated by one of the minicores 201 (e.g., MC#0) may be delivered to another one of the minicores 201 (e.g., MC#3) through the external network 202.

A configuration of the external network 202, e.g., a connection state between the minicores 201, may vary based on configuration information. For example, the configuration of the external network 202 may vary based on the configuration information stored in a memory, e.g., the configuration memory 113 of FIG. 1.

The minicores 201 may include the same or different computing powers. For example, one of the minicores 201 (e.g., MC#0) may perform operations A, B, C and D, and another one of the minicores 201 (e.g., MC#2) may perform operations A, C and E. The minicores 201 may be configured to perform at least one same operation. Two or more of the minicores 201 (e.g., MC#0 and MC#1) may be combined to perform the same operation based on a data type (16 bits, 32 bits, 64 bits, 128 bits, etc.) of an SIMD instruction.

In another example, each of the minicores 201 may include a local register file (not shown). Each of the minicores 201 may temporarily store data in the local register file.

In another example, the reconfigurable processor 200, namely, the processing unit 101, may operate as a CGA processor or a VLIW processor. For example, when the reconfigurable processor 200 operates as the CGA processor in a CGA mode, four of the minicores 201 (e.g., MC#3 through MC#6) process a loop operation based on a CGA architecture. When the reconfigurable processor 200 operates as the VLIW processor in a VLIW mode, some of the minicores 201 (e.g., MC#0 and MC#2) process an operation other than the loop operation based on a VLIW architecture.

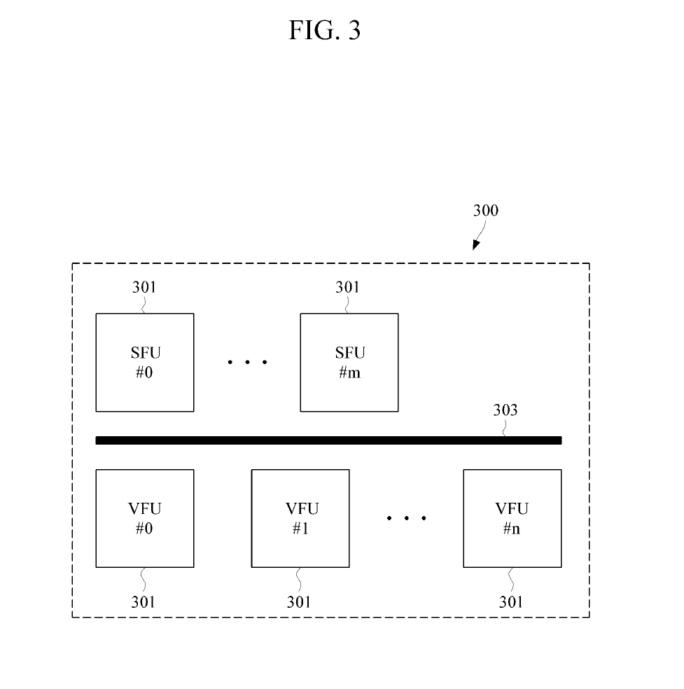

FIG. 3 is a diagram illustrating an example of a minicore 300 of a reconfigurable processor. Referring to FIG. 3, the minicore 300 includes two or more function units 301 and an internal network 303 that connects the function units 301 to each other. Each of the function units 301 may perform a scalar operation (e.g., SFU#0) or a vector operation (e.g., VFU#0).

In more detail, the function units 301 included in the minicore 300 may perform different operations, respectively. That is, not all operations of an application are processed by one of the function units 301. Instead, the operations of the application are distributed to the respective function units 301. In addition, the function units 301 configured in the minicore 300 can perform almost all or all of the operations of the application.

For example, operations A, B, C and D may be distributed to and processed by four of the function units 301 (e.g., VFU#0 through VFU#3), respectively. These four of the function units 301 (e.g., VFU#0 through VFU#3) may form the minicore 300 to process all operations of an application. However, this is merely an example, and the function units 301 can be configured to execute various operations.

A number m or n of the function units 301 can be increased or decreased as desired. Any one the function units 301 may be configured to perform the same operation as function units of other minicores.

The internal network 303 enables the function units 301 to communicate with each other. For example, data generated by one of the function units 301 (e.g., VFU#0) may be delivered to another one of the function units 301 (e.g., VFU#1) through the internal network 303.

A configuration of the internal network 303, e.g., a connection state between the function units 301, may vary based on configuration information. For example, the configuration of the internal network 303 may vary based on the configuration information stored in a memory, e.g., the configuration memory 113 of FIG. 1.

In another example, the minicore 300 may include a local register file (not shown), which corresponds to each of the function units 301 and temporarily stores various processing results of the function units 301. In this example, the minicore 300 may temporarily store results of processing SIMD instructions in the local register file, and use the stored results. Therefore, the minicore 300 supports SIMD processing without a vector register file.

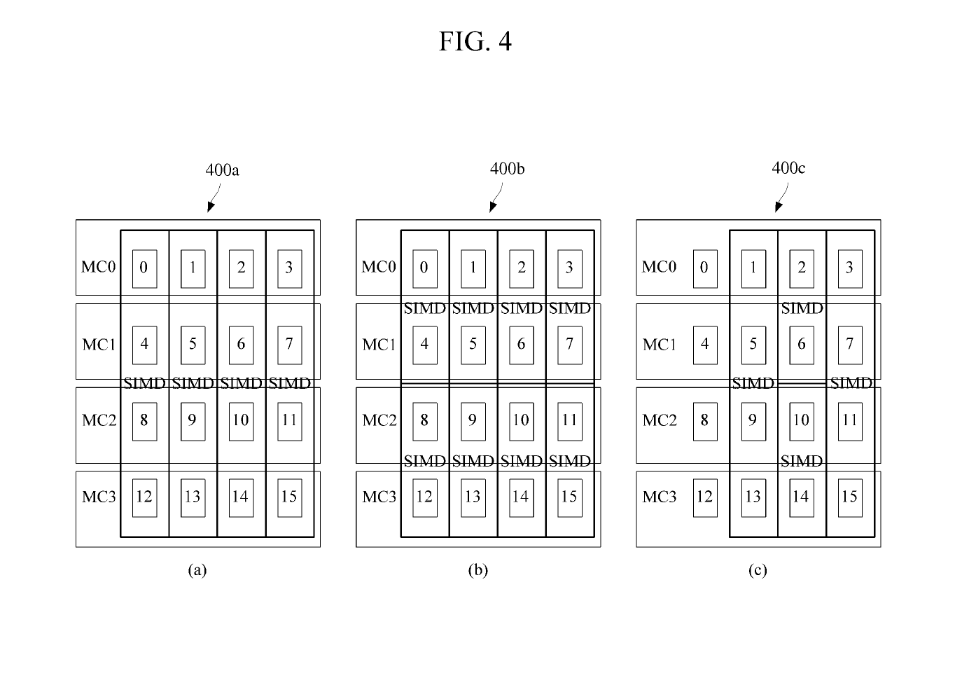

FIG. 4 is a diagram illustrating an example of SIMD resources formed flexibly in a CGA mode. A leftmost section (a) and a middle section (b) show examples of SIMD resources of a predetermined size formed in the CGA mode, and a rightmost section (c) shows examples of SIMD resources of flexible sizes formed in the CGA mode.

In the CGA mode, each of function units 0 through 15 may be utilized to form SIMD resources or scalar resources, which are combinations of the function units 0 through 15, or of four minicores MC0 through MC3. For example, various SIMD resources may be formed based on a data type of a SIMD instruction.

For example, the leftmost section (a) shows SIMD resources 400a formed when a data type of a decoded SIMD instruction is 128 bits. The four minicores MC0 through MC3 include the same computing power, that is, the same operation processing capability. In more detail, function units 0, 1, 2, and 3 of the minicore MC0, function units 4, 5, 6 and 7 of the minicore MC1, function units 8, 9, 10 and 11 of the minicore MC2, and function units 12, 13, 14 and 15 of the minicore MC3 may perform the same operations A, B, C and D, respectively. Each of the function units 0 through 15 can process 32 bits of data. Since the data type of the decoded SIMD instruction is 128 bits, the SIMD instruction can be processed by combining, e.g., the function units 0, 4, 8 and 12 of the four minicores MC0 through MC3 into a SIMD resource, and using the SIMD resource to process the operation A of the SIMD instruction.

In another example, the middle section (b) shows SIMD resources 400b formed when a data type of a decoded SIMD instruction is 64 bits. The SIMD resources 400b used to process 64-bit data are formed by combining two of the function units of the minicores MC0 and MC1, or of the minicores MC2 and MC3, that perform the same operations. For example, the function units 0 and 4 of the minicores MC0 and MC1 are combined into a SIMD resource, which is used to process the operation A of the SIMD instruction.

In still another example, the rightmost section (c) shows SIMD resources 400c formed flexibly based on decoded SIMD instructions. That is, the function units, which perform the same operations, of a different number of the respective minicores MC0 through MC3 may be combined based on the SIMD instructions in order to flexibly form the SIMD resources 400c. For example, the function units 0, 4, 8 and 12 of the minicores MC0 through MC3 perform different operations, and are not combined to form a SIMD resource. The function units 1, 5, 9 and 13 of the minicores MC0 through MC3 perform the same operation, the function units 2 and 6 of the minicores MC0 and MC1 perform the same operation, the function units 10 and 14 of the minicores MC2 and MC3 perform the same operation, and the function units 3, 7, 11, and 15 of the minicores MC0 through MC3 perform the same operation. Accordingly, these functional units are respectively combined to form the SIMD resources 400c.

In the VLIW mode, SIMD resources can be formed flexibly as well. For example, if an operation obtained by decoding an issued SIMD instruction is 32-bit, and each function unit can process 32 bits, a corresponding function unit performs the operation. If the operation is 64 or more-bit, and each function unit can process 32 bits, function units of a number of minicores, that is, two or more minicores, are combined to perform the operation. In another example, a 128-bit operation in a SIMD instruction is processed using function units of four minicores.

To improve data processing performance by increasing data parallelism, a bandwidth of a data path may be increased. According to the teachings above, however, function units of each minicore can be flexibly connected to each other based on a data type of an SIMD instruction to form SIMD resources. Therefore, operations can be processed without having to increase the bandwidth of the data path.

As described above, a reconfigurable processor configured to flexibly form SIMD resources may store processing results of function units in a local register file (not shown). Therefore, a vector register file configured to support a vector type, and additional resources for parallel processing, are not required, and SIMD instructions can be flexibly supported using the local register file.

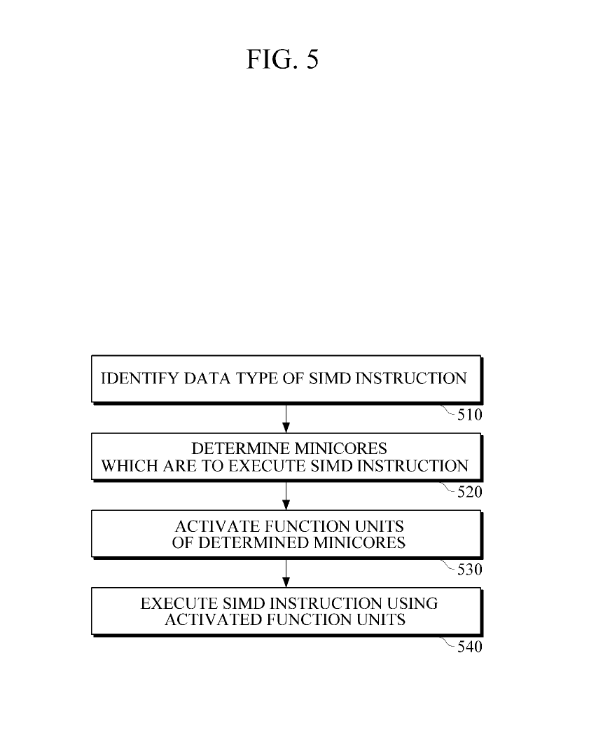

FIG. 5 is a flowchart illustrating an example of a method of flexibly processing multiple data using a reconfigurable processor. Referring to FIG. 5, in operation 510, a processing unit 101 of the reconfigurable processor decodes an issued SIMD instruction, and identifies a data type (e.g., an amount of bits of data) of the decoded SIMD instruction.

In operation 520, the processing unit 101 determines or combines minicores, which are to execute the SIMD instruction, based on the data type of the decoded SIMD instruction. The minicores that are to execute the SIMD instruction may be determined further based on a data size that each function unit of each minicore can process. Therefore, SIMD instructions with various data types can be processed.

For example, if each function unit can process 32 bits of data, and the data type of the decoded SIMD instruction is 64 bits, two minicores are determined to execute the SIMD instruction. That is, if the data type is 64 bits, SIMD resources including two minicores can be formed as shown in the middle section (b) of FIG. 4. In another example, if each function unit can process 32 bits of data, and the data type of the decoded SIMD instruction is 128 bits, four minicores are determined to execute the SIMD instruction. That is, if the data type is 128 bits, SIMD resources including four minicores can be formed as shown in the leftmost section (a) of FIG. 4. In still another example, in order for a reconfigurable processor to process various SIMD instructions, a different number of minicores may be connected based on the SIMD instructions to flexibly form SIMD resources as shown in the rightmost section (c) of FIG. 4.

In operation 530, the processing unit 101 activates function units of the determined minicores. The activated function units of the determined minicores may perform the same operation of the SIMD instruction.

For example, referring to the leftmost section (a) of FIG. 4, the four minicores MC0 through MC3 include the same computing power, that is, the same operation processing capability. That is, the function units 0, 1, 2, and 3 of the minicore MC0, the function units 4, 5, 6 and 7 of the minicore MC1, the function units 8, 9, 10 and 11 of the minicore MC2, and the function units 12, 13, 14 and 15 of the minicore MC3 may perform the same operations A, B, C and D, respectively. Referring to the rightmost section (c) of FIG. 4, the function units 0, 4, 8 and 12 of the minicores MC0 through MC3 perform different operations, and are not combined to form a SIMD resource. The function units 1, 5, 9 and 13 of the minicores MC0 through MC3 perform the same operation, the function units 2 and 6 of the minicores MC0 and MC1 perform the same operation, the function units 10 and 14 of the minicores MC2 and MC3 perform the same operation, and function units 3, 7, 11, and 15 of the minicores MC0 through MC3 perform the same operation. Accordingly, these functional units are respectively combined to form the SIMD resources 400c, and activated to execute respective SIMD instructions.

In operation 540, the processing unit 101 executes the SIMD instruction using the activated function units. In addition, the activated function units may record a result of the execution in a local register file.

The units described herein may be implemented using hardware components and software components. For example, the hardware components may include microphones, amplifiers, band-pass filters, audio to digital convertors, and processing devices. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more computer readable recording mediums. The computer readable recording medium may include any data storage device that can store data which can be thereafter read by a computer system or processing device. Examples of the non-transitory computer readable recording medium include read-only memory (ROM), random-access memory (RAM), CD-ROMs, magnetic tapes, floppy disks, optical data storage devices. Also, functional programs, codes, and code segments accomplishing the examples disclosed herein can be easily construed by programmers skilled in the art to which the examples pertain based on and using the flow diagrams and block diagrams of the figures and their corresponding descriptions as provided herein.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A reconfigurable processor comprising:
minicores, each of the minicores comprising function units configured to perform different operations, respectively; and
a processing unit configured to activate two or more function units of two or more respective minicores, among the minicores, that are configured to perform an operation of a single instruction multiple data (SIMD) instruction, the processing unit further configured to execute the SIMD instruction using the activated two or more function units.

2. The reconfigurable processor of claim 1, wherein one of the function units included in one of the minicores performs a same operation as one of the function units included in another one of the minicores or in each other one of the minicores.

3. The reconfigurable processor of claim 1, wherein the processing unit is further configured to:
determine the two or more minicores, which are to execute the SIMD instruction, based on a data type of the SIMD instruction.

4. The reconfigurable processor of claim 1, wherein each of the minicores is configured to:
temporarily store a result of the execution of the SIMD instruction.

5. The reconfigurable processor of claim 1, further comprising:
an external network configured to connect the minicores to each other.

6. The reconfigurable processor of claim 1, wherein each of the minicores further comprises:
an internal network configured to connect the function units to each other.

7. The reconfigurable processor of claim 1, wherein the processing unit is further configured to:
operate as a minicore-based coarse-grained array (CGA) processor, or as a minicore-based very long instruction word (VLIW) processor.

8. The reconfigurable processor of claim 7, wherein each of the minicores comprises a basic design unit or a basic extension unit in the CGA processor or the VLIW processor.

9. The reconfigurable processor of claim 7, wherein:
the CGA processor is configured to perform a loop operation; and
the VLIW processor is configured to perform an operation other than the loop operation.

10. The reconfigurable processor of claim 1, wherein the processing unit is further configured to:
identify a data type of the SIMD instruction, the data type comprising an amount of bits of data.

11. A method of processing multiple data using a reconfigurable processor, the method comprising:
determining two or more minicores, among minicores of the reconfigurable processor, that are to execute a SIMD instruction; and
activating two or more function units of the determined two or more minicores, respectively, that perform an operation of the SIMD instruction.

12. The method of claim 11, wherein each of the minicores comprises function units that perform different operations, respectively.

13. The method of claim 12, wherein one of the function units included in one of the minicores performs a same operation as one of the function units included in another one of the minicores, or in each other one of the minicores.

14. The method of claim 11, wherein the determining of the two or more minicores comprises:
determining the two or more minicores, which are to execute the SIMD instruction, based on a data type of the SIMD instruction.

15. The method of claim 11, further comprising:
executing the SIMD instruction using the activated two or more function units.

16. The method of claim 15, further comprising:
storing a result of the execution of the SIMD instruction.

17. The method of claim 11, further comprising:
operating as a minicore-based CGA processor, or as a minicore-based VLIW processor.

18. The method of claim 17, wherein:
the CGA processor performs a loop operation; and
the VLIW processor performs an operation other than the loop operation.

19. The method of claim 11, further comprising:
identifying a data type of the SIMD instruction, the data type comprising an amount of bits of data.

20. A computer-readable storage medium storing a program to process the multiple data, comprising instructions to cause a computer to implement the method of claim 11.
